(19) United States
(12) Patent Application Publication
(10) Pub. No.: US 2020/0187313 A1
(43) Pub. Date: Jun. 11, 2020

(54) FORMING MACHINE

(71) Applicant: ENGEL AUSTRIA GmbH, Schwertberg (AT)

(72) Inventors: Rainer HOELZL, Tragwein (AT); Andreas Josef FRIES, Schwertberg (AT)

(21) Appl. No.: 16/690,396

(22) Filed: Nov. 21, 2019

(30) Foreign Application Priority Data
Dec. 11, 2018 (AT) A 51098/2018

(51) Int. Cl. H05B 6/36; F27B 14/06

(52) U.S. Cl. CPC H05B 6/36; B22D 17/30; F27B 14/061

(57) ABSTRACT

A shaping machine comprising an induction coil for inductive heating, in particular melting, of a material, and a body substantially surrounding the induction coil, wherein the body substantially radially and/or axially surrounding the induction coil is a magnetic and/or magnetizable body.

The present invention concerns a shaping machine in accordance with the features of the classifying portion of claim 1. Shaping machines of the general kind set forth include an induction coil for inductively heating, in particular melting of a material, a shaping cavity for the heated or molten material and a body substantially surrounding the induction coil.

By way of example WO 2013/043156 A1 discloses such a shaping machine, wherein the body surrounding the induction coil is in the form of a shield which protects the environment from the electromagnetic radiation emitted by the induction coil.

A disadvantage with the structure disclosed there is that the shield is of a large and cumbersome structure and is heated by the currents induced by the electromagnetic field so that cooling is necessary. The shields also disclosed in WO 2013/043156 A1 in the form of conductor meshes may be insignificant from the point of screening effectiveness at the intensities and frequencies necessary for melting metal.

The object of the invention is to permit heating or melting of the material of a shaping machine with a higher level of efficiency and/or to at least not worsen the emission of electromagnetic waves outwardly.

That object is attained by a shaping machine having the features of claim 1. That is effected by the body substantially axially and/or radially surrounding the induction coil being a magnetic and/or magnetizable body.

The term magnetizable bodies is used to mean those to which their own (temporary or sustained) magnetic moment can be imparted by applying a magnetic field.

By using a magnetic and/or magnetizable body the magnetic field generated by the induction coil is concentrated from the outset much more strongly on the near field and in particular on the interior of the induction coil, wherein the technical effect pursued in WO 2013/043156 A1 is automatically achieved. At the same time a higher electromagnetic energy density is produced within the induction coil by the concentrated magnetic field whereby heating and/or melting of the material occurs with a higher level of effectiveness (that is to say higher electromagnetic energy density within the induction coil with otherwise identical actuation of the induction coil).

Those components of the shaping machine which are arranged outside the induction coil and the surrounding magnetic and/or magnetizable body also experience lower levels of electromagnetic loading and thus lower thermal loadings, by virtue of the invention.

The material to be heated and/or melted can be any conductor as currents can be induced in those materials, which leads to the liberation of heat. In particular the material can be a metal. The term “heating” is also used to denote “melting”.

The heated and/or molten material can be put into the desired shape by means of the shaping cavity.

A (longitudinal) axis can be associated with the induction coil.

The statement that—for example—the body substantially axially surrounds the induction coil can in particular be taken to mean that the body surrounds a notional, for example roughly cylindrically shaped peripheral surface of the induction coil over a large part (for example more than half, preferably more than three quarters and particularly preferably completely). In other words the body is for a large part of a peripherally extending configuration in relation to the axis of the induction coil.

The statement that—for example—the body substantially radially surrounds the induction coil can be taken in particular to mean that the body overlaps the induction coil in a view along the axis, wherein in particular the overlap surrounds the axis for a large part (for example more than half, preferably more than three quarters and particularly preferably completely). In other words the overlap can for a large part be of a peripherally extending configuration around the axis.

By virtue of the invention it is also possible for the surrounding magnetic and/or magnetizable body to be brought closer to the coil, whereby it is possible to achieve an overall smaller structure. In particular the spacing between the induction coil and the body can be less than a tenth, preferably less than a fiftieth and particularly preferably less than a hundredth of the diameter of the induction coil.

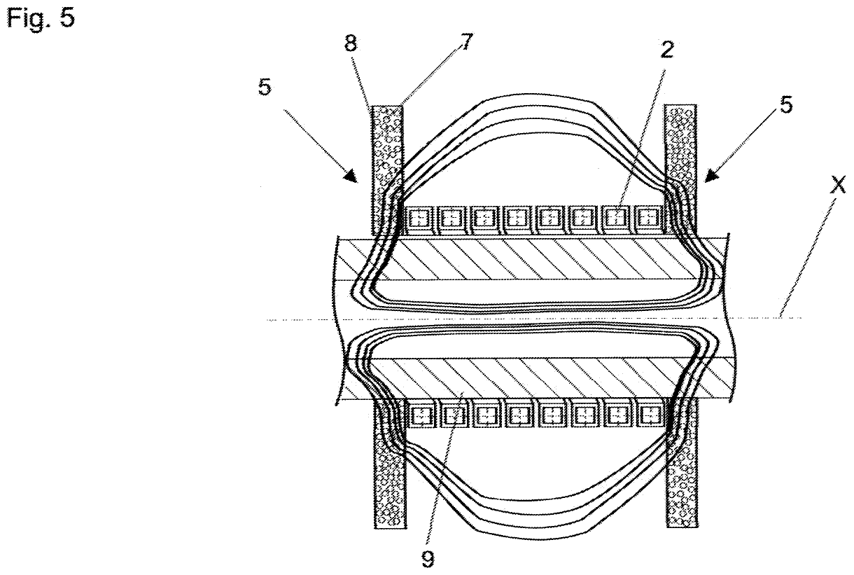

A magnetic and/or magnetizable body substantially axially surrounding the induction coil also affords an additional screening effect for those components which are arranged axially in the proximity of the induction coil and the surrounding body (see in that respect the example in FIG. 5).

Further advantageous embodiments of the invention are defined in the appendant claims.

Particularly preferably there can be provided a shaping cavity for the heated and/or molten material. In other words, by introducing the heated and/or molten material into the shaping cavity and then cooling it, in particular hardening it, in the shaping cavity, it is possible to carry out a shaping process in the form of a casting process.

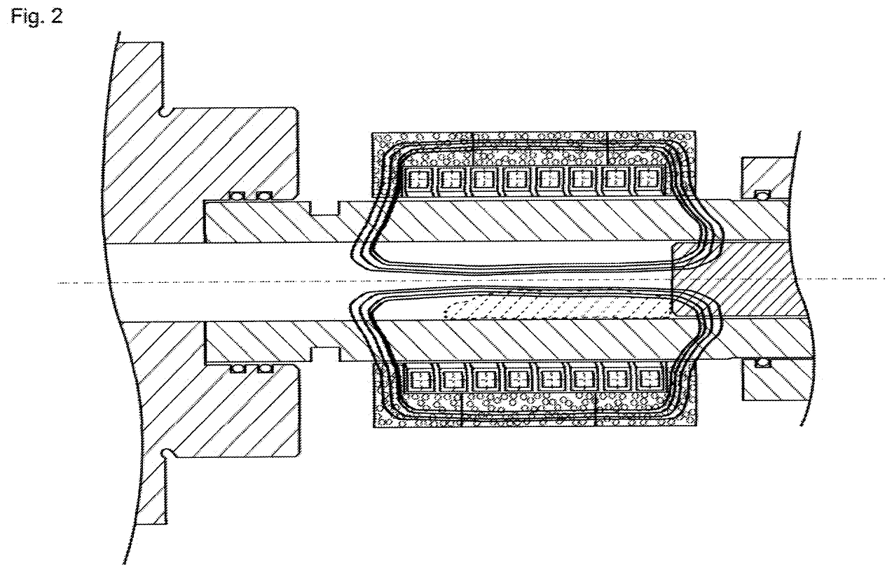

It can be provided that the magnetic and/or magnetizable body substantially radially surrounding the induction coil at at least one end of the induction coil—preferably at both ends of the induction coil—has an additional element which at least partially—preferably completely—overlaps the induction coil in a view along an axis of the induction coil. Such an additional element deflects the magnetic field lines so that they also remain closer to the induction coil at the ends and thereby finally are also deflected inwardly. Besides the additional concentration function for the magnetic field this also affords an additional shielding effect for those components which are arranged in the proximity of the induction coil and the surrounding body (see in that respect the example in FIG. 2).

It can be provided that the additional element at least partially overlaps a central opening of the induction coil, which opening is present in the view along the axis. Just a relatively small overlap of the opening of the induction coil by the additional element can be useful. In particular the minimum spacing which is to be maintained from a melting vessel to the surrounding body can be less than that spacing between the melting vessel and the induction coil.

It can particularly preferably be provided that the additional element is in the form of an extension of the magnetic and/or magnetizable body. In other words the extension can embrace the induction coil at the end.

Because the additional element is an extension of the magnetic and/or magnetizable body it is possible to prevent a gap being formed between the main body of the magnetic and/or magnetizable body and the additional element, which gap would weaken the concentration function of the body for the magnetic field.

Particularly preferably the additional element is in the form of a peripherally extending web which faces inwardly from the magnetic and/or magnetizable body. That arrangement could also be identified as an inwardly facing flange on the magnetic and/or magnetizable body.

What applies for the additional element which is in the form of an extension, in relation to the magnetic and/or magnetizable body, also applies generally to the magnetic or magnetizable body. In that sense the magnetic and/or magnetizable body can be of a continuous or cohesive structure, in which respect it can additionally be advantageous if there are no holes in the magnetic or magnetizable body.

This does not prevent the magnetic and/or magnetizable body being capable of being of a multi-part structure. It is preferred in that respect however if either that is not the case or the individual parts of the magnetic and/or magnetizable body are in direct contact with each other. Ultimately however the advantage of the invention can still be achieved to a certain degree even when the magnetic and/or magnetizable body is not continuous and for example involves gap dimensions which do not exceed a tenth, preferably a fiftieth and particularly preferably a hundredth of the diameter of the magnetic and/or magnetizable body. That also applies for any spacing between the main body of the magnetic and/or magnetizable body and the additional element already referred to hereinbefore.

The magnetic and/or magnetizable body can include a ferromagnetic and/or paramagnetic material. The magnetic and/or magnetizable body can include magnetic and/or magnetizable particles (for example ferromagnetic and/or paramagnetic) which are embedded in a non-magnetic matrix. That can serve to suppress induced currents within the magnetic and/or magnetizable body. That effect however could also be achieved for example with suitable layer structures within the magnetic and/or magnetizable body.

The magnetic and/or magnetizable body substantially radially surrounding the induction coil, in a particularly simple structure, can be of a substantially cylindrical basic shape, which is possibly adjoined by the above-mentioned additional element. The term cylindrical basic shape can be used to mean for example a straight circular cylinder. Alternative basic surfaces for the cylinder however are also certainly conceivable (oval, elliptical, square, hexagonal, generally polygonal).

The magnetic and/or magnetizable body substantially axially surrounding the induction coil can be of a substantially disk-shaped—preferably annular—basic shape. Instead of a circular disk it is also possible here to use alternative basic surfaces (oval, elliptical, square, hexagonal, generally polygonal).

The induction coil can be substantially in the form of a helix (that is to say coiled screw-like).

Particularly preferably there can be provided a melting vessel separate from the shaping cavity for receiving the material to be heated and/or melted, the induction coil being arranged at said melting vessel. In a particularly preferred embodiment the melting vessel can be made from a ceramic material (in one part or a plurality of parts).

Particularly preferably the induction coil substantially surrounds the melting vessel—preferably substantially radially.

A particularly simple structure is also conducive when the melting vessel is of a substantially cylindrical configuration.

In a particularly simple embodiment the melting vessel, the induction coil and the magnetic and/or magnetizable body are arranged concentrically around a central axis.

Particularly in that case it can be provided that the melting vessel has openings oriented exclusively in the axial direction of the induction coil. On the one hand that in itself is a particularly simple embodiment.

On the other hand there is a particularly preferred embodiment when there is a slider for pushing the heated and/or molten material out of the melting vessel into the shaping cavity, wherein the slider is then to be moved in the axial direction of the induction coil. A slider for pushing out the heated and/or molten material can however also be provided in other arrangements of the melting vessel.

Further advantages and details of the invention will be apparent from the Figures and the related description. In the Figures:

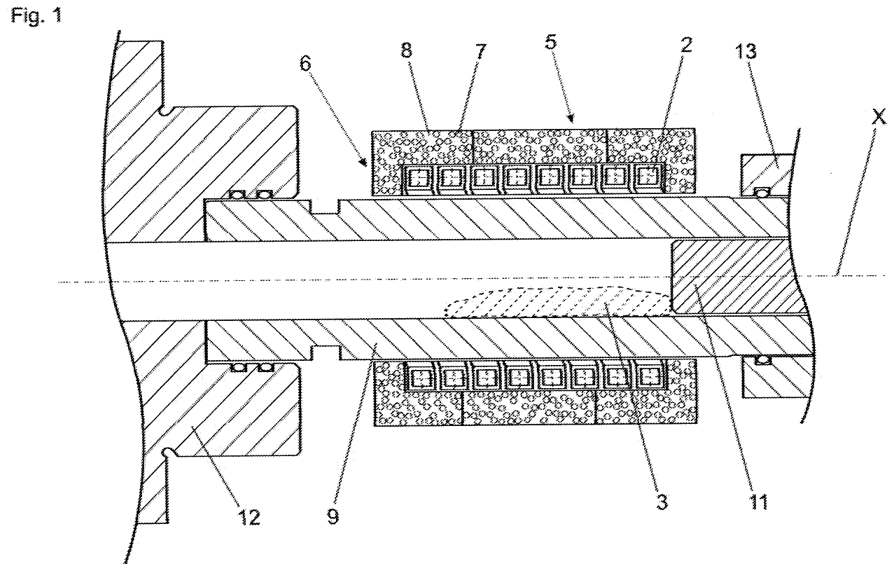

FIG. 1 shows a sectional view of a shaping machine according to the invention,

FIG. 2 shows the view of FIG. 1, with the magnetic field being displayed,

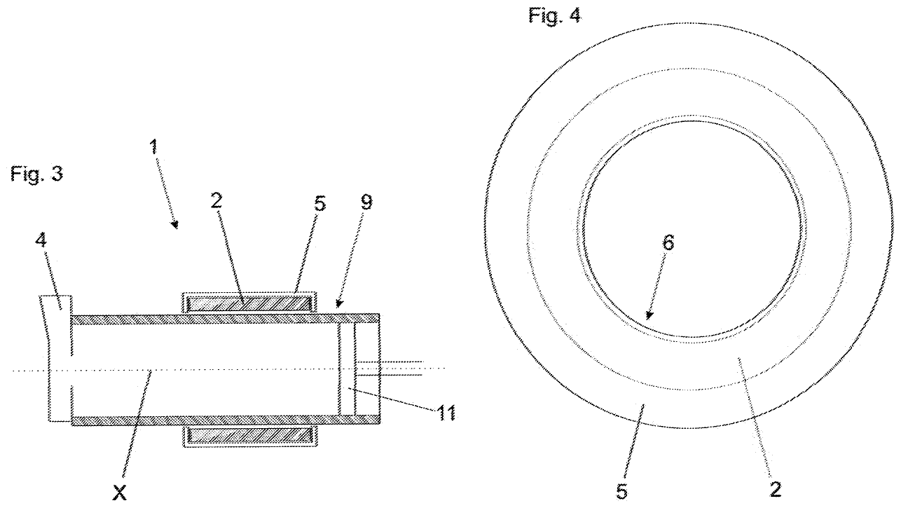

FIG. 3 shows a further view illustrating the principle of the shaping machine according to the invention with shaping cavity,

FIG. 4 shows a view of an embodiment according to the invention along an axis of the induction coil, and

FIG. 5 shows an embodiment according to the invention, wherein the body axially surrounds the induction coil.

In the embodiment of the invention shown in FIG. 1 it is possible to see firstly the melting vessel 9, the induction coil 2 and the surrounding magnetic and/or magnetizable body 5. They are oriented and arranged concentrically around a central axis X.

The directions along the axis X of the induction coil 2 are identified as axial and the directions perpendicular thereto are identified as radial.

In this embodiment the magnetic and/or magnetizable body 5 comprises three parts to simplify production. The material of the magnetic and/or magnetizable body 5 is a non-magnetic matrix 8 in which magnetic and/or magnetizable particles 7 are embedded (indicated in the drawing).

The magnetic and/or magnetizable particles 7 are shown as being of circular shape in the Figures for the sake of simplicity. In reality the particles 7 are chip-shaped.

Disposed within the melting vessel 9 is the material 3 (in this case a metal) which was inductively heated and is now in a molten state.

The melting vessel 9 has exclusively openings facing in the direction of the axis X. A slider 11 can be guided through one of those openings (from the right in the view in FIG. 1), by means of which slider the molten material 3 can be pushed out towards the left. Disposed there is the shaping cavity 4 (see FIG. 3), into which the molten material 3 is pushed under pressure. The material 3 is cooled in the shaping cavity 4 in such a way that a crystalline solid body is substantially formed.

References 12 and 13 denote further parts of the shaping machine 1. The melting vessel 9 is produced from a ceramic material to impart a high resistance to thermal loadings to the melting vessel 9. The further parts of the shaping machine 1 denoted by references 12 and 13 are however of a metallic material. The invention and in particular the additional elements 6 in the form of extensions guide the magnetic field in such a way that the metallic parts 12 and 13 experience lower electromagnetic and thereby thermal loadings (in comparison with a structure without the additional elements 6).

In this respect attention is directed to FIG. 2 showing the same embodiment as FIG. 1. In this case the references have been omitted for the sake of simplicity, but magnetic field lines are now shown to display the magnetic field which occurs due to the magnetic and/or magnetizable body 5 according to the invention. As already mentioned the magnetic and/or magnetizable body 5 guides the magnetic fields away from any metallic attachments and concentrates the magnetic field (and thus naturally also the electrical field) within the body and within the induction coil 2, which also means: within the melting vessel 9. That concentration of the electromagnetic field within the melting vessel 9 affords a higher electromagnetic energy density at the location of the material 3 which is to be heated and/or melted, with the desired effect that heating and/or melting takes place more effectively.

As already mentioned FIG. 3 shows a shaping machine 1 according to the invention with the shaping cavity 4. The technical configuration of the melting vessel 9, the induction coil 2 and the magnetic and/or magnetizable body 5 is similar to that of FIGS. 1 and 2.

The mode of operation is similar, this applying in particular also to the slider 11.

FIG. 4 shows a view of the magnetic and/or magnetizable body 5 along the central axis X which is perpendicular to the plane of the drawing and is arranged in the center of the central opening. In this view the magnetic and/or magnetizable body 5 appears annular. The induction coil 2 is also shown in dotted form, the induction coil 2 however being completely covered (that is to say overlapped) by the additional element 6 of the magnetic and/or magnetizable body 5. That also applies for a small part of the central opening of the induction coil 2.

FIG. 5 shows an embodiment wherein the body 5 axially surrounds the induction coil 2. As the displayed magnetic field lines show this also affords a concentration of the magnetic field within the melting vessel 9 and shielding in relation to external, axially arranged, further components, similarly to the embodiment of FIGS. 1 and 2.

It is pointed out the axis X does not necessarily have to be straight, that is to say it can also be curved. The geometries of the melting vessel 9, the induction coil 2 and the magnetic and/or magnetizable body can then follow that curved geometry. Moreover however it is not even necessary for for example the melting vessel 9 to be cylindrical.

1. A shaping machine comprising
an induction coil for inductive heating, in particular melting, of a material, and
a body substantially surrounding the induction coil,
wherein the body substantially radially and/or axially surrounding the induction coil is a magnetic and/or magnetizable body.

2. The shaping machine as set forth in claim 1, wherein the magnetic and/or magnetizable body substantially radially surrounding the induction coil at at least one end of the induction coil—preferably at both ends of the induction coil—has an additional element which at least partially—preferably completely—overlaps the induction coil in a view along an axis of the induction coil.

3. The shaping machine as set forth in claim 2, wherein the additional element at least partially overlaps a central opening of the induction coil, which opening is present in the view along the axis.

4. The shaping machine as set forth in claim 2, wherein the additional element is in the form of an extension of the magnetic and/or magnetizable body.

5. The shaping machine as set forth in claim 2, wherein the additional element is in the form of a peripherally extending web which faces inwardly from the magnetic and/or magnetizable body.

6. The shaping machine as set forth in claim 1 the magnetic and/or magnetizable body includes a ferromagnetic and/or paramagnetic material.

7. The shaping machine as set forth in claim 1, wherein the body contains magnetic and/or magnetizable particles embedded in a non-magnetic matrix.

8. The shaping machine as set forth in claim 1, wherein the magnetic and/or magnetizable body is continuous.

9. The shaping machine as set forth in claim 1, wherein the magnetic and/or magnetizable body substantially radially surrounding the induction coil is of a substantially cylindrical basic shape.

10. The shaping machine as set forth in claim 1, wherein the magnetic and/or magnetizable body substantially axially surrounding the induction coil is of a substantially disk-shaped—preferably annular—basic shape.

11. The shaping machine as set forth in claim 1, wherein the induction coil is substantially in the form of a helix.

12. The shaping machine as set forth in claim 1, wherein there is provided a melting vessel separate from the shaping cavity for receiving the material to be heated and/or melted, the induction coil being arranged at said melting vessel.

13. The shaping machine as set forth in claim 12, wherein the induction coil substantially surrounds the melting vessel—preferably substantially radially surrounds same.

14. The shaping machine as set forth in claim 12, wherein the melting vessel is of a substantially cylindrical configuration.

15. The shaping machine as set forth in claim 12, wherein the melting vessel has openings oriented exclusively in the axial direction of the induction coil.

16. The shaping machine as set forth in claim 12, wherein the melting vessel is made from a ceramic material—preferably monolithically.

17. The shaping machine as set forth in claim 12, wherein there is provided a slider for pushing the heated and/or molten material out of the melting vessel into the shaping cavity, preferably being moveable in an axial direction of the induction coil.

18. The shaping machine as set forth in claim 1, wherein there is provided a shaping cavity for the heated and/or molten material.
